(19) United States
(12) Patent Application Publication
(10) Pub. No.: US 2021/0363464 A1
(43) Pub. Date: Nov. 25, 2021

(54) Desulfurized Crude Tall Oil Compositions and Processes for Producing

(71) Applicant: KRATON POLYMERS LLC, Houston, TX (US)

(72) Inventors: Jos H.M. Lange, Almere (NL); Sebastiaan J. Steenkamer, Almere (NL); Francis E. Swan, Savannah, GA (US); Randy Rogers, Savannah, GA (US)

(73) Assignee: KRATON POLYMERS LLC, Houston, TX (US)

(21) Appl. No.: 17/302,982

(22) Filed: May 18, 2021

Related U.S. Application Data
(60) Provisional application No. 62/704,659, filed on May 20, 2020.

(51) Int. Cl. C11B 13/02; C11B 3/08; C11B 3/04

(52) U.S. Cl. CPC C11B 13/02; C11B 3/04; C11B 3/08

(57) ABSTRACT

A method to produce crude tall oil (CTO) having a reduced sulfur content is disclosed. Black liquor soap (BLS) is treated with 0.05 to 0.45% by weight H₂O₂. Hydrogen peroxide treated BLS compositions, CTO compositions, and chemical compositions derived thereof, including depitched CTO, TOP, depitched CTO distillation fractions, and products derived therefrom are disclosed. The use of a small amount of H₂O₂ results in a decreased degree of foaming.

### RELATED APPLICATIONS

This application claims priority from U.S. Provisional Application No. 62/704,659, with a filing date of May 20, 2020, the entire disclosure of which is incorporated herein by reference.

### FIELD

The disclosure relates to methods to produce crude tall oil (CTO) having a reduced sulfur content, CTO compositions, and chemical compositions derived thereof.

### BACKGROUND

The Kraft process in the paper pulping industry produces black liquor soap (BLS), which can be collected by skimming it from the concentrated black liquor surface. BLS in general has a sulfur content which typically ranges from about 1200-3000 ppm. BLS is acidified with sulfuric acid to form crude tall oil (CTO) on an industrial scale. The CTO is then dewatered and depitched to form depitched tall oil, which in turn is fractionated to obtain tall oil fatty acid and tall oil rosin fractions.

CTO derived fractions and products include tall oil heads (TOH), tall oil fatty acid (TOFA), distilled tall oil (DTO), and tall oil rosin (TOR) fractions and a distillation residue. These fractions can be further chemically upgraded, for example TOR can be esterified with polyalcohols into tall oil rosin esters and TOFA can be converted into fatty acid dimers, fatty acid monomers and tall oil fatty amides. Sulfur compounds in materials produced from BLS, such as CTO and CTO derived fractions and products, can limit the scope of end use applications, e.g., due to malodor.

Sulfur impurities are generally known to act as noble metal catalyst poisoners, can have a detrimental impact on catalytic hydrogenation and disproportionation reactions. BLS desulfurization processes are known in the prior art. Some apply hydrogen peroxide (H₂O₂) and aqueous solutions thereof. H₂O₂ can lead to a considerable degree of foaming due to decomposition and release of O₂.

Thus, there is still a need for improved BLS desulfurization processes with a low or negligible degree of foam formation, low CTO sulfur content, and high CTO recovery yield after BLS acidulation.

### SUMMARY

In one aspect, the disclosure relates to a method to produce crude tall oil (CTO) with reduced sulfur level. The method comprises, or consists essentially of, or consists of: treating black liquor soap (BLS) with 0.05 to 0.45% by weight H₂O₂, based on the weight of the BLS; acidulation of the treated BLS into CTO; and recovering the CTO phase from the aqueous phase and from residual solids. The recovered CTO is characterized as having a sulfur level of at least 15% lower than the sulfur level in CTO recovered from untreated BLS. In embodiments, the recovered CTO has a sulfur content of <900 ppm.

In embodiments, the BLS treatment step is at a temperature of 0° C. to 105° C., or at 40° C. to 90° C., for 1 minute to 48 hours, or for 5 minutes to 36 hours, or from 1 to 5 hours.

In other embodiments, the BLS is treated with 0.1 to 0.35% by weight H₂O₂, or with 0.2 to 0.3% by weight of H₂O₂, based on the weight of the BLS.

In yet other embodiments, the treatment of black liquor soap (BLS) with H₂O₂ results in a reaction mixture volume increase due to foaming of than 50%, or less than 20%, or less than 10%.

In yet another aspect, the disclosure provides CTO derived products with reduced sulfur level, including but not limited to TOH, TOFA, DTO, and TOR, prepared from the recovered CTO treated by the desulfurization method described herein.

### DESCRIPTION

The following terms used the specification have the following meanings:

“Odor intensity” refers to the strength of an odor, or sensation of the odor results from the interaction of volatile chemical substances with the olfactory system. Odor intensity can be expressed by an odor intensity scale with a numerical value as under the

Offensive Odor Control Act of Japan: 0 (no odor), 1 (barely perceivable odor), 2 (weak but barely discernible odor), 3 (easily discernible odor), 4 (rather strong), 5 (intense). For example, concentrations at the odor intensity grade 5 indicating intense odor are: 40 ppm with ammonia, 8 ppm with hydrogen sulfide, 0.2 ppm with methyl mercaptan, 1.9 ppm with acetic acid, and 10 ppm with acetaldehyde. Odor intensity assessment can be carried out by a panel of organoleptically trained experts.

The disclosure relates to a method for treating BLS with a relatively small amount of H₂O₂, leading to a substantially lower degree of foaming while still removing a considerable amount of sulfur and odor in the recovered CTO after acidulation, and in CTO derived fractions and products.

Black Liquor Soap (BLS) Feedstock: Black liquor, from which tall oil is obtained, is an aqueous solution separated from the cellulosic portions of wood in the manufacture of paper pulp by alkaline processes. It typically contains fatty acid soaps, resin soaps (rosin acid sodium salts), and unsaponifiable organic compounds. The fatty acids are predominantly oleic and linoleic acid with small quantities of linolenic, stearic and palmitic acid. The rosin acids are abietane and pimarane diterpenoid monocarboxylic acids. The predominant rosin acids are abietic acid, isomers thereof, and dehydroabietic acid.

When the black liquor from the Kraft process is concentrated, a large proportion of the soap will separate and can be collected by skimming it from the concentrated black liquor surface. BLS in general contains 25-40 wt. % of entrained water and has a sulfur content which typically ranges from 1200-3000 ppm. Anhydrous BLS constitutes the remaining solid BLS fraction after evaporation of the entrained water. BLS inherently has an odor due to the presence of volatile components, including methylmercaptan, sulfur containing components such as sulfides, e.g., with an odor intensity grade of at least 2, or at least 3, on odor intensity scale of Offensive Odor Control Act, with an unpleasant hedonic tone.

Hydrogen peroxide H₂O₂: H₂O₂ can be applied in the form of an aqueous solution, e.g., 30-35 or 50 wt. % H₂O₂. For example, 0.1 wt. % H₂O₂ corresponds to 0.2 wt. % of a 50 wt. % aqueous solution of H₂O₂.

Method for Desulfurization: BLS is purified for the removal of sulfur by being brought into contact with H₂O₂ via contact methods and equipment known in the art. The treatment with H₂O₂ is carried out in a liquid state wherein the BLS is mechanically agitated between BLS freezing and boiling conditions, which is from approximately 0° C. to 100° C.

In embodiments, BLS is treated with 0.05 to 0.45 wt. % H₂O₂, or from 0.3 to 0.45 wt. % H₂O₂, from 0.1 to 0.40 wt. % H₂O₂, or from 0.1 to 0.35 wt. % H₂O₂, or 0.15 to 0.35 wt. % H₂O₂, or 0.2 to 0.3 wt. % H₂O₂, based on the weight of the BLS.

In embodiments, the treatment is at a temperature of 0° C. and the boiling point of the reaction mixture, or from 0° C. to 105° C., or 0° C. to 80° C., 0° C. to 70° C., or 0° C. to 60° C., 0° C. to 50° C., or 10° C. to 105° C., or 30° C. to 105° C., or 40° C. to 105° C., or 50° C. to 105° C., or 60° C. to 105° C., or 40° C. to 100° C., 50° C. to 90° C., or 50° C. to 80° C., or at least 10° C., or at least 30° C., or at least 50° C., or at least 75° C.

The treatment in embodiments range from 1 minute to 48 hours, or from 5 minutes to 48 hours, or from 5 minutes to 36 hours, or at least 15 minutes, or up to 24 hours, or 1 to 5 hours, or for at least 3 hours.

In the treatment of BLS with H₂O₂, foaming of BLS occurs due to the decomposition of H₂O₂, wherein in particular O₂ gas is formed. In embodiments with the BLS treatment being at a relatively low temperature such as at room temperature, there is negligible or just a minor low level of foaming. In embodiments, the amount of foaming, being the maximal volume increase of the reaction mixture during and after the H₂O₂ treatment prior to the acidulation stage, is <75%, or <50%, or <25%, or <10%. The relative volume increase of the reaction mixture due to foaming can be expressed as a percentage. Foaming due to the decomposition of excess H₂O₂ in BLS typically occurs at temperatures higher than approximately 45° C.

After the treatment of BLS with H₂O₂, the resulting reaction mixture is acidulated by the addition of an acid, e.g., a mineral acid such as HCl or H₂SO₄ (e.g., 50 wt. % aqueous H₂SO₄ solution) wherein the pH value is decreased to the range between 1 to 4, or 1.5 to 3, or about 2, to produce crude tall oil. In embodiments, steam may be used to maintain an acidulation temperature in the range of 70° C. to 103° C., or between 90° C. and 100° C., or >70° C., or <105° C. In other embodiments, heat and agitation may be used to maintain acidulation temperature in the range of 70° C. to 103° C., or between 90° C. and 100° C., or >70° C., or <105° C. Tall oil rosin acid salts and fatty acid salts as present in BLS are converted during acidulation into the corresponding carboxylic acids in the crude tall oil phase, with the product mixture in embodiments comprising an aqueous acidic phase, and solid sodium sulfate brine, precipitated lignin residuals, and inorganic salts. The solids can be removed by methods such as decantation, filtration or centrifugation.

After acidulation, the liquid CTO phase is separated from the aqueous phase and residual solids by known methods such as decantation, applying a separatory funnel, aqueous extraction, dewatering, etc. In embodiments, the amount of recovered CTO is >75 wt. % (based on total weight of CTO and solid residue), or >80%, or >82%, or >84%, based on the amount of anhydrous BLS.

Properties: The isolated or recovered crude tall oil (CTO) has a significantly reduced concentration of sulfur compared with CTO recovered from a process without the H₂O₂ treatment of BLS, with the sulfur content reduced by >15%, or >20%, or >25%, or >30%, or >35%, or >45%, or >50%, or with a sulfur concentration of <1000 ppm, or <900 ppm, or <800 ppm, or <750 ppm, or <700 ppm, or <600 ppm, or <500 ppm.

In addition to sulfur content reduction, the obtained CTO can also exhibit other favorable features such as improved color, color stability, and improved odor properties such as reduced odor intensity and ameliorated odor hedonic tone properties. Odor hedonic tone refers to the degree of pleasantness of an odor. The odor intensity reduction is at least 1 unit, or at least 2 units on the odor intensity scale of 0 to 5 of Offensive Odor Control Act.

Sulfur Reduction Mechanism: Not wishing to be limited by the following mechanism, it is believed that sulfides are known to rapidly react with H₂O₂ into the corresponding sulfoxides. The formed sulfoxides can further react with H₂O₂ into sulfones. In general, this conversion of sulfoxides into sulfones is known to proceed with considerably lower reaction rates at a given temperature than the conversion of sulfides into sulfoxides. In addition, the conversion of sulfides into sulfones will require substantially more H₂O₂ than in case of conversion of sulfides into sulfoxides. Sulfoxides are known to be more polar than the corresponding sulfides and in general slightly more polar than sulfones, and as such can be relatively easily removed from CTO in an aqueous extraction process.

C—S covalent bonds in sulfoxides are known to have a lower bond dissociation energy than C—S bonds in the corresponding sulfides and sulfones. For example, the homolytic C-S bond cleavage energy of dimethylsulfide is about 40% higher as compared to the C—S bond cleavage energy of dimethylsulfoxide. The homolytic C—S bond cleavage energy of dimethylsulfone is about 20-25% higher as compared to the C—S bond cleavage energy of dimethylsulfoxide. This can be advantageous since during a process at elevated temperature, such as fractionation during CTO depitching and depitched CTO fractional vacuum distillation, aliphatic sulfoxides can more easily thermally decompose as compared to aliphatic sulfides and sulfones. Due to their decreased molecular weights, the thus formed sulfurous components have a higher degree of volatility and as such can escape in gaseous form during such high temperature fractionations under reduced pressure. For example, formed gaseous sulfurous components can be condensed in a cold trap or collected by gas scrubbing.

The thermal decomposition reactions of, in particular sulfoxides, can further contribute to a reduction in sulfur content in CTO derived fractions, e.g., depitched CTO fractions, depitched CTO vacuum distillate fractions such as TOR. Recovered CTO can be distilled and sold for use as is, or in embodiments, the CTO can be fractionated for a number of different CTO derived fractions and products.

CTO Derived Fractions and Products: The CTO recovered from the above BLS treatment method having reduced sulfur contents can further processed by any of depitching and subsequent fractionations and chemical reactions into dehydrated crude tall oil, tall oil pitch (TOP) and depitched CTO distillation fractions, including TOR, TOFA, TOH and DTO, and chemical compositions derived thereof. In embodiments, the CTO is depitched into separate desired acid components from unwanted neutrals through vaporization, the remaining non-volatile liquid, the tall oil pitch (TOP), is retained from the process. Depitching can be by using a stripper column, or via dry distillation method using thin film, wiped film, or short path evaporators.

In one embodiments, CTO derived products include phytosterols and policosanol fractions for use in nutraceuticals and dietary supplements, obtained by known purification methods, e.g., short path evaporation, crystallization, extraction and combinations thereof. Examples of sterols are beta-sitosterol and campesterol. Policosanols are long chain fatty alcohols with carbon backbones ranging from 24 to 34 carbons.

In other embodiment, compositions derived from the desulfurized TOFA compositions include TOFA amides, TOFA diamides, TOFA dimer, TOFA dimer derived polyamides, TOFA monomer and hydrogenated TOFA derivatives such as isostearic acid and stearic acid. TOFA dimer derived polyamides can be synthesized from TOFA dimer and ethylenediamine. Palmitic acid is a major component of TOH. Phytosterols, such as beta-sitosterol and campesterol, and policosanols are components of TOP.

In embodiments, compositions derived from the desulfurized TOFA include TOFA monomers. TOFA monomer is the monomeric fraction formed during the acidic clay-catalyzed polymerization of TOFA. In this polymerization process, the olefinic fatty acids undergo a variety of chemical reactions, including isomerizations and intermolecular addition reactions, so as to form a mixture of dimerized and polymerized fatty acid as well as a unique mixture of monomeric fatty acids. The monomeric fatty acids fraction separated from the polymerization product is known as “monomer” or “monomer acid” or “monomer fatty acid,” or tall oil fatty acid monomer (CAS Registry Number 68955-98-6). TOFA monomer is typically a mixture of branched-, aromatic-, cyclic-, and straight-chain fatty acids, which may be saturated or unsaturated and wherein olefinic bonds can have cis- or trans-configuration. An example is “iso-oleic acid”, where iso-oleic acid is a mixture of linear, branched and cyclic C18 mono-unsaturated fatty acids.

In embodiments, compositions derived from desulfurized TOR include disproportionated rosin, hydrogenated rosin and rosin esters, e.g., disproportionated rosin esters and hydrogenated rosin esters. Rosin esters are derived from one or more TOR and one or more polyhydric alcohols having 2-30 carbon atoms and 2-10 average hydroxyl functionality, including ethylene glycol, propylene glycol, diethylene glycol, triethylene glycol, tetraethylene glycol, trimethylene glycol, trimethylolpropane, trimethylolethane, 4,4′-isopropylidenedicyclohexanol, 1,4-cyclohexanedimethanol, 2,2,4,4-tetramethyl-1,3-cyclobutanediol, 4,8-bis(hydroxymethyl)tricyclo[5.2.1.0^{2,6}]decane, glycerol, diglycerol, polyglycerol, polyglycerol-2, polyglycerol-3, polyglycerol-4, pentaerythritol, dipentaerythritol, tripentaerythritol, mannitol, sorbitol, and xylitol.

In embodiments, compositions derived from desulfurized TOR are rosin esters derived from an one or more desulfurized TOR and one or more polyhydric alcohols having 2-30 carbon atoms and 2-10 average hydroxyl functionality alcohol, and optionally up to 10 wt. % of one or more dicarboxylic acid functional organic compounds, e.g., malonic acid, succinic acid, glutaric acid, adipic acid, pimelic acid, suberic acid, azelaic acid, sebacic acid, undecanedioic acid, dodecanedioic acid, hexadecanedioic acid, isophthalic acid, 1,2-cyclohexanedicarboxylic acid, terephthalic acid, 1,3-cyclohexanedicarboxylic acid, 1,4-cyclohexanedicarboxylic acid, 3-methyladipic acid, camphoric acid, cis-norbornene-endo-2,3-dicarboxylic acid, 1,3-cyclopentanedicarboxylic acid, polymerized rosin, rosin dimer, and mercusic acid.

In embodiments, compositions derived from desulfurized TOFA and TOR include oligoesters, which are derived from one or more TOR, one or more TOFAs, one or more polyhydric alcohols, and optionally up to 10 wt. % of all reactants of one or more dicarboxylic acid functional organic compounds.

In embodiments, compositions derived from the desulfurized TOFA include tall oil fatty acid esters originating from a chemical reaction of TOFA with monofunctional alcohols such as methanol and ethanol, or drying or semidrying alkyd TOFA esters produced from TOFA, dicarboxylic acids or anhydrides, such as phthalic anhydride and maleic anhydride, and polyols, such as trimethylolpropane, glycerol, and pentaerythritol.

In embodiments, desulfurized compositions derived from desulfurized TOP include compositions prepared from TOP, such as TOP esters originating from a chemical reaction of TOP with one or more polyhydric alcohols having 2 to 30 carbon atoms and having 2 to 10 average hydroxyl functionality, and optionally more than 0 up to 10 wt. % of all reactants of one or more dicarboxylic acid functional organic compounds.

The desulfurized CTO-derived compositions described above are characterized as having a lower sulfur content than compositions prepared from conventional CTO compositions, i.e., CTO compositions obtained from BLS that has not been treated with H₂O₂. In embodiment, the reduction in sulfur content is any of >15%, or >20%, or >25%, or >30%, or >35%, or >40%, or >50%. The desulfurized CTO-derived compositions are also characterized as having reduced odor intensity and ameliorated odor hedonic tone properties, with the odor intensity being reduced by at least one odor intensity scale unit as compared to the corresponding compositions originating from BLS that has not been treated with H₂O₂.

In embodiments, depitched CTO prepared from the desulfurized CTO has a total sulfur content of <650 ppm, or <550 ppm, or <450 ppm, or <400 ppm, or <350 ppm, or <300 ppm. The depitched CTO has a color of any of less than 8 Gardner, 7 Gardner, and 6 Gardner. TOR prepared from the desulfurized CTO has a sulfur content reduced by at least any of 25%, 30%, 35%, 40%, 50%, 55%, and 60%, or a total sulfur content of less than any of 600 ppm, 500 ppm, 400 ppm, 350 ppm, 300 ppm, 250 ppm, 200 ppm, and 150 ppm.

EXAMPLES: The following examples are intended to be non-limiting.

In the examples, BLS materials originating from United States pine forestry were used. Water content of the collected BLS fractions after centrifugation (3000 rpm for 3 min) amounted to 30-35 wt %.

BLS water content was derived by either determining the weight (mass) difference between aqueous BLS starting material and obtained anhydrous BLS after heating to 160° C. in an oven under N₂ for 1 hour, or by using an electronic moisture analyzer.

Sulfur content was measured with an ANTEK® 9000 sulfur analyzer and according to ASTM D5453-05. Sulfur content can also be determined by Inductively Coupled Plasma with optical emission spectroscopy (ICP-OES) or mass spectrometry (ICP-MS). Sulfur content of BLS samples was determined with ICP-OES. Sulfur content of CTO, depitched CTO, TOP, and TOR samples was determined with ANTEK® 9000 analyzer.

Gardner color was measured according to ASTM D1544-04 (2010), using a LICO® 200 colorimeter.

VTA Short path evaporator, VKL 70-4 (Niederwinkling, GER) was applied.

Mettler Toledo MP220 pH meter was applied.

Rosin acid and tall oil fatty acid content in CTO and its fractionation products were determined according to ASTM D5974-00 (2010).

BLS was determined according to ASTM D5974-00 (2010), starting with the acidulation with dilute HCl to convert BLS into corresponding CTO composition.

Weight percent: wt. %; hour: h; minute: min; gram: g; liter: L; nitrogen: N₂; sulfur: S; aqueous: aq.; Short path evaporator: SPE; C: Celcius; rpm: revolutions per min.

Example 1. BLS (1042.6 g) was added to a 2 L four-necked round bottom flask, equipped with thermocouple, mechanical stirrer, and dropping funnel. The stirred BLS was heated to 65° C., and subsequently 17.81 g of a 35 wt. % aq. solution of H₂O₂ was slowly added. The resulting mixture was stirred for 30 min at 65° C. The volume of the reaction mixture had increased at this stage approximately 100% due to foaming.

The reaction mixture was further heated to 80° C. and acidulated by slowly adding 50 wt. % aq. H₂SO₄, while monitoring pH, until a pH value of 2 was obtained. The resulting mixture was subjected to centrifugation (3000 rpm for 3 min). The liquid CTO phase was separated from the aqueous phase and solids and subsequently SPE-depitched at a pressure of 0.2 mbar, at 180° C., by applying a feed rate of 356 mL/min.

A depitched CTO distillate and a TOP residue were obtained at a weight ratio of 81% and 19%. Results showed S content: BLS 2616 ppm (ICP), CTO 524 ppm, depitched CTO 243 ppm, TOP 1301 ppm.

Example 2. Example 1 was repeated but with 3455 g of BLS and 58.79 g of a 35 wt. % aq. solution of H₂O₂. At the end of H₂O₂ addition stage, volume of the reaction mixture had increased approximately 100% due to foaming. A depitched CTO distillate and a TOP residue were obtained in a weight ratio of 84% and 16%. Results show S content: BLS 2399 ppm (ICP), CTO 654 ppm, depitched CTO 299 ppm, TOP 971 ppm.

Example 3. Example 1 was repeated but with 818.7 g of BLS and 13.9 g of a 35 wt. % aq. solution of H₂O₂. The volume of the reaction mixture had increased at the end of H₂O₂ addition stage approximately 100% due to foaming. A depitched CTO distillate and a TOP residue were obtained in a weight ratio of 84% and 16%. Results showed S content: BLS 1386 ppm (ICP), CTO 788 ppm, depitched CTO 259 ppm, TOP 2217 ppm.

Example 4. Example 1 was repeated but with 1012.9 g BLS, with the modification that no BLS H₂O₂ treatment prior to acidulation was applied. A depitched CTO distillate and a TOP residue were obtained in a weight ratio of 78% and 22%. Results showed S content: BLS 2616 ppm (ICP), CTO 685 ppm, depitched CTO 394 ppm (color 8.4 Gardner), TOP 1324 ppm.

Example 5. Example 4 was repeated but with 13.405 kg of BLS—no BLS H₂O₂ treatment prior to acidulation. A depitched CTO distillate and a TOP residue were obtained in a weight ratio of 84% and 16%. Results showed S contents: BLS 2399 ppm (ICP), CTO 1003 ppm, depitched CTO 452 ppm (color 8.0 Gardner), TOP 1606 ppm.

Example 6. Example 1 was repeated but with 2854.3 g of BLS, and 0.4 wt. % H₂O₂ (32.35 g of a 35 wt. % aq. solution of H₂O₂) instead of 0.6 wt. % H₂O₂. A depitched CTO distillate and a TOP residue were obtained in a weight ratio of 88% and 12%. Results showed S content: BLS 2213 ppm (ICP), CTO 716 ppm, depitched CTO 281 ppm (color 7.4 Gardner).

Example 7. Example 1 was repeated but with 1342 g of BLS, and two modifications: (a) 0.2 wt. % H₂O₂(7.6 g of a 35 wt. % aq. solution of H₂O₂) was used instead of 0.6 wt. % H₂O_{2;} and (b) the H₂O₂ treatment was conducted at room temperature for 3 h, prior to heating the reaction mixture to 80° C. for the acidulation step. No volume increase by foaming was observed. A depitched CTO distillate and a TOP residue were obtained in a weight ratio of 84% and 16%. Results showed S contents: BLS 2616 ppm (ICP), CTO 549 ppm, depitched CTO 308 ppm, TOP 1402 ppm.

Example 8. Example 1 was repeated with 1144.5 g of BLS and the following two modifications: (a) 0.1 wt. % H₂O₂ (3.19 g of a 35 wt. % aq. solution of H₂O₂) was used instead of 0.6 wt. % H₂O₂ and (b) the H₂O₂ treatment was conducted at room temperature for 3 h, prior to heating the reaction mixture to 80° C. for the acidulation step. No volume increase by foaming was observed. A depitched CTO distillate and a TOP residue were obtained in a weight ratio of 80% and 20%. Results showed S content: BLS 2616 (ICP) ppm, CTO 623 ppm, depitched CTO 327 ppm, TOP 1296 ppm.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

Unless otherwise specified, the recitation of a genus of elements, materials or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A method to produce crude tall oil (CTO) comprising:
treating a black liquor soap (BLS) by mixing with 0.05 to 0.45% by weight H₂O₂, based on total weight of the BLS for 1 minute to 48 hours at a temperature of 0° C. to 105° C.;
acidulating the treated BLS to a pH value ranging between 1 to 4, wherein a CTO phase, an aqueous phase and residual solids are formed;
maintaining the acidulating temperature in the range of 70 to 103° C.; and
separating the CTO phase from the aqueous phase and from residual solids at a recovery yield of at least 75% CTO based on total weight of anhydrous BLS; and
wherein the recovered CTO has a sulfur content of less than 900 ppm.

2. The method of claim 1, wherein the BLS is treated with 0.1 to 0.35% by weight H₂O₂, at a temperature of 40° C. to 90° C.

3. The method claim 2, wherein the mixture of BLS and H₂O₂ has a volume increase of less than 50% during and after the treatment with H₂O₂.

4. The method of claim 1, wherein the BLS is treated for 5 minutes to 36 hours.

5. The method of claim 1, wherein the mixture of BLS and H₂O₂ has a volume increase of less than 20% during and after the treatment with H₂O₂.

6. The method of claim 1, wherein the acidulation temperature is maintained by any of the addition of steam.

7. The method of claim 1, wherein the recovered CTO has a sulfur content that is at least 15% lower than the sulfur content of CTO recovered from a BLS not treated with H₂O₂.

8. The method of claim 1, wherein the recovered CTO has an odor intensity reduction of at least 1 unit compared to the odor intensity of a CTO recovered from a BLS not treated with H₂O₂.

9. The method of claim 8, wherein the recovered CTO has an odor intensity reduction of at least 2 units.

10. The method of claim 1, further comprising recovering CTO to generate a depitched CTO distillate and TOP residue.

11. The method of claim 10, wherein the CTO is recovered by any of distillation or evaporation.

12. A depitched CTO obtained from the method of claim 10, having a sulfur content of less than 350 ppm.

13. A tall oil pitch composition, a tall oil fatty acid composition, a tall oil rosin composition, a tall oil heads composition, or a distilled tall oil composition obtained from the depitched CTO composition of claim 12.

14. The tall oil rosin composition of claim 13, wherein the sulfur content is reduced by at least 25% as compared to a tall oil rosin which originates from untreated BLS.

15. The tall oil pitch composition, a tall oil fatty acid composition, a tall oil rosin composition, a tall oil heads composition, or a distilled tall oil composition obtained from the depitched CTO composition of claim 12, having an odor intensity of at least 1 unit lower to the odor intensity of compositions which originate from untreated BLS.

16. A composition obtained by subjecting the compositions of claim 13 to one or more processes selected from dimerization, trimerization, isomerization, aromatization, disproportionation, catalytic hydrogenation, esterification or amidation reactions.

17. The composition of claim 16, wherein the composition is a tall oil rosin ester composition, distilled tall oil ester composition, tall oil fatty acid ester composition, tall oil pitch ester composition, tall oil fatty acid dimer composition, tall oil fatty acid trimer composition, tall oil fatty acid monomer composition, tall oil fatty acid dimer derived polyamide composition, tall oil fatty acid dimer derived diamide composition, tall oil fatty acid derived diamide composition, tall oil fatty acid derived monoamide composition, tall oil fatty acid monomer derived diamide composition, tall oil fatty acid monomer derived monoamide composition, palmitic acid, stearic acid, isostearic acid, a phytosterol composition, beta-sitosterol, campesterol, or policosanol composition.

18. A CTO composition obtained from the method of claim 1.

19. The CTO composition of claim 18, having a sulfur content of less than 750 ppm.

20. The CTO composition of claim 18, having an odor intensity reduction of at least 1 unit as compared to the composition derived from a BLS not treated with H₂O₂.
